(19) United States
(12) Patent Application Publication
(10) Pub. No.: US 2006/0159828 A1
(43) Pub. Date: Jul. 20, 2006

(54) Sports drink and method therefor

(75) Inventor: Scott B. Uehlein, Tucson, AZ (US)

Correspondence Address: LEWIS L. LOCKWOOD;LEWIS AND ROCA LLP, 40 NORTH CENTRAL AVENUE, PHOENIX, AZ, 85004, US

(73) Assignee: CR License, LLC, Tucson, AZ (US)

(21) Appl. No.: 11/294,924

(22) Filed: Dec. 5, 2005

Related U.S. Application Data
(60) Provisional application No. 60/633,314, filed on Dec. 3, 2004.

(51) Int. Cl. A23F 3/00

(52) U.S. Cl. 426/597

(57) ABSTRACT

A sports drink is presented, along with its method of composition and use. The sports drink of the present invention is produced primarily with natural and organic ingredients, yet provides a good-tasting beverage that ameliorates the effects of strenuous exercise and assists with obtaining a desirable body mass index.

### CROSS REFERENCES TO RELATED APPLICATIONS

This application claims the full benefit and priority of U.S. Provisional Application Ser. No. 60/633,314, filed on Dec. 3, 2004, titled “Sports Drink and Method Therefor,” the disclosure of which is fully incorporated herein for all purposes.

### STATEMENT REGARDING FEDERALLY SPONSORED RESEARCH OR DEVELOPMENT

Not applicable.

### BACKGROUND OF THE INVENTION

1. Field of the Invention

This invention relates to beverage compositions intended for human consumption. More particularly, the present invention relates to a sports drink comprised of natural substances that is flavorful and ameliorates the effects of physical exertion, yet avoids many of the downfalls of commercially-available sports drinks.

2. Description of the Related Art

Through breathing and perspiration, physical exercise depletes a person's bloodstream of water, electrolytes, and available sugars. This depletion can become severe enough to manifest in a loss of performance, fatigue, cramps and, ultimately, exhaustion. To counteract the physiological effects of exercise, commercially-available sports drinks such as Gatoraide® were developed and marketed, and are advertised for use by athletes and those participating in strenuous physical activities.

Existing commercial sports drinks are often touted as being effective at replenishing lost electrolytes, carbohydrates, and water. Many of these drinks, however, are unattractive to health-conscious individuals. While in some instances they may be helpful in rehydration, the abovementioned commercial sports drinks often contain artificial flavors, colors, sweeteners and preservatives; buffering agents; and refined glucose, sucrose, and/or dextrose. Further, consumption-ready beverages containing farm-product derivates such as tea (Camellia Sinensis) extracts often use plant matter not obtained from certified organic sources, and therefore, traces of herbicides, pesticides, and other undesirable chemical components may be transferred to the beverage with the tea extract. While health-conscious individuals would like to partake of beverages that assist with fitness goals, sports performance, and post-exercise recovery, they are often deterred from ingesting substances of questionable health value and safety, and therefore are often restricted to water intake to ameliorate the effects of exercise.

The plant Ilex Paraguariensis (common name Yerba Mate) has long been known as a source for a healthy and refreshing tea that is derived from an infusion of hot water with its leaves and stemlets. Its ability to invigorate and improve alertness and/or attentiveness without causing caffeine-like jitters is well known, and contributes to its popularity as a social drink in areas of the world such as South America. Some of the compounds known to be present in Yerba Mate infusions and drinks include xanthines (stimulating compounds similar to caffeine, theophylline, and theobromine), polyphenols (powerful phytochemical antioxidants), and vitamins and minerals (A, C, E, B1, B2, B3, B5, iron, manganese, magnesium, and potassium). When taken by persons in the proper amounts, such compounds are known to assist the human body in maximizing performance and achieving fitness goals such as a healthy body mass index.

While adequate intake of water is essential to maintain proper hydration, it is desirable to provide a drink that not only replaces lost water from exercise-related respiration and perspiration, but also provides a healthful and attractive-tasting combination of ingredients that assists with obtaining fitness goals. Therefore, what is needed is a sports drink that provides water, antioxidants, electrolytes, and energy sources in the form of natural sugars and carbohydrates through the use of natural, wholesome ingredients. Further, what is needed is a sports drink that provides natural infusions of teas or herbs to enhance a human body's ability to energize, maintain alertness, re-hydrate, and achieve a healthful body mass index.

### SUMMARY OF THE INVENTION

In view of the foregoing, it is an object of the present invention to improve various problems associated with the prior art. To this end, an object of the invention is to provide an improved sports drink to ameliorate the effects of physical exercise. It is another object of this invention to provide a beverage to improve alertness and attentiveness. It is another object of the present invention to provide a sports drink that provides a flavorful refreshment through the use of natural and organic ingredients. It is yet another object of the invention to provide for a sports drink beverage that also contains extracts or infusions of teas or herbs known to assist with physiological goals, such as achieving a healthy body mass index and enhancement of available metabolic energy.

The present invention provides for a healthful sports beverage by combining certain herbal infusions and/or extracts with other natural ingredients such as fruit juices to provide a unique balance of antioxidants, beneficial alkaloids, vitamins, and minerals. By way of example but not of limitation, infusions, extracts or derivatives from the organically-grown plant Ilex Paraguariensis (common name Yerba Mate) may be added to the sports drink that includes one or more organically-grown fruit juices, water, and electrolytes. To further enhance taste or other end effects, other herbs and/or teas such as Camellia Sinensis may be added to the sports drink along with the extracts or infusions of Ilex Paraguariensis.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed. Thus, the present invention comprises a combination of features, steps, and advantages that enable it to overcome various deficiencies of the prior art. The various characteristics described above, as well as other features, will be readily apparent to those skilled in the art upon reading the following detailed description of the preferred embodiments of the invention.

### DETAILED DESCRIPTION

To prepare one embodiment of the sports drink of the present invention, certain tea compositions are brewed by steeping in hot water, and after the brewed tea is cooled (for example, but not by way of limitation, by adding ice), other ingredients are added (such as electrolytes and fruit juices). The ingredients for the present invention are mixed during this process, using any conventional form of mixing such as blending, stirring, or shaking. Optionally, the prepared beverage could be bottled and pasteurized to protect freshness.

To make approximately two liters of one embodiment of the sports drink of the present invention, the following example composition list is provided:

### EXAMPLE I

A drinkable beverage combination producing approximately two liters of beverage can be prepared from the following ingredients:

| Ingredient | Measurement | % Composition, +/−10% |
|---|---|---|
| Water + Ice (melted) | 1.065 liters | 53.2 v/v |
| Salt | 2-3 grams | 0.1-0.15 w/w |
| Tea Composition 1 | 1 individual-sized | -trace- |
| | portion | |
| Tea Composition 2 | 1 individual-sized | -trace- |
| | portion | |
| White Grape Juice | 0.235 liters | 11.8 v/v |
| Orange Juice | 0.580 liters | 29.0 v/v |
| Apple Juice | 0.120 liters | 6.00 v/v |
| Concentate | | |

In reference to the table above, 1 individual-sized portion is a sufficient quantity of tea composition normally used to brew one individual cup-size serving of hot tea. For example, but not by way of limitation, one individual-sized portion of tea composition could comprise the amount of tea used in 1 teabag, or about 2.1 grams of tea. Alternatively, each individual-sized portion of tea composition could comprise an amount of tea and/or herb extract that when diluted in approximately six U.S. ounces of water, would provide a prepared beverage concentration approximately equivalent to such amount of beverage prepared with approximately six U.S. ounces of water and an individual-sized teabag of such tea and/or herb. Those of skill in the art recognize that the weight or volume of the tea composition used to prepare the sports beverage can vary since the density of teas varies substantially based on the moisture content and the type of plant, fruit, or herbs used in the tea composition. In one embodiment, Tea Composition 1 comprises a blend of Yerba Mate, lemon myrtle leaves, lemongrass, ginger root, licorice root, ginseng leaves, and cardamom, and Tea Composition 2 comprises a blend of Yerba Mate and natural tropical fruit flavors. In another embodiment, Tea Composition 1 comprises Yerba Mate, and Tea Composition 2 comprises a blend of green tea and orange/black pekoe tea. Those of skill in the art further appreciate that the percentage composition of the beverage in terms of Tea Composition 1 and Tea Composition 2 varies depending on the particular tea used and the brewing time and temperature, and contributes a small (shown above as “trace”), but potentially variable percentage composition of the entire sports drink formulation.

Those of skill in the art may immediately recognize that the above list of ingredients and method may be modified to produce a larger or smaller volume of beverage through increasing or decreasing the listed ingredients proportionally, for instance, by multiplying each ingredient measurement by a predetermined scaling factor. One of skill in the art also recognizes that differing types of tea may be utilized to achieve different flavors, as well as different types or amounts of juices. One may also recognize that ingredients used may be restricted to only certified organic ingredients, and water utilized in an embodiment of the drink may be carbonated. Further, the proportions shown may vary +/−10% for each component, depending on taste or other factors. In addition, various natural or organic additives may be added to increase the nutritional value of the beverage, such as herbal extracts, brewed herbal teas, vitamins, minerals, amino acids, and the like.

To prepare the sports drink beverage, in a sufficiently large heat-resistant container, the above-referenced tea compositions are placed into hot water and steeped in the hot water for approximately five minutes. Those of skill in the art recognize that to prevent spent tea leaves from remaining in the beverage, the tea compositions may be isolated from the beverage liquid by a manner that allows infusion without spent particles remaining behind, for instance, by using filters, teabags, or strainers. The temperature of the hot water may vary with the kind and amount of tea used—for instance, primarily black tea could be brewed at a temperature approaching 212° F., oolongs could be brewed between 190° F. and 195° F., and green or some herbal teas could be brewed at less than 180° F. In general, a temperature range of 160-190° F. is preferred, and boiling temperatures should be avoided. After the brewing step, the tea compositions are removed from the container and moisture squeezed out, allowing the fluid removed from the bags to re-enter the container. Ice is then added to reduce the temperature of the brewed tea. The salt and the remaining ingredients are then added, and the liquid is mixed well to combine the ingredients.

An alternate embodiment for the present invention is presented below, in units of measure and quantities adapted to allow individuals to more easily produce an embodiment of the beverage.

### EXAMPLE II

A drinkable beverage combination producing approximately two liters of beverage can be prepared from the following ingredients:

| | |
|---|---|
| Hot Water | 2 cups |
| Ice | about 2½ cups |
| Salt | ½ teaspoon |
| Tea Composition 1 | 1 tea bag, such as those available |
| | as TAZO ® Lemon Maté ® |
| Tea Composition 2 | 1 tea bag, such as those available |
| | as TAZO ® Maté Tropic |
| White Grape Juice | 1 cup |
| Orange Juice | 2½ cups |
| Apple Juice | ½ cup |
| Concentrate | |

Method of Formulation:

In a 2 quart container, the tea bags for Tea Composition 1 and Tea Composition 2 are placed into the hot water and steeped in the hot water for approximately five minutes. The temperature of the hot water may vary with the kind and amount of tea used—for instance, primarily black tea could be brewed at a temperature approaching 212° F., oolongs could be brewed between 190° F. and 195° F., and green or some herbal teas could be brewed at less than 180° F. In general, a temperature range of 160-190° F. is preferred, and boiling temperatures should be avoided. After the brewing step, the salt is added to the container, then the tea bags are removed from the container and moisture squeezed out, allowing the fluid removed from the bags to re-enter the container. A sufficient quantity of ice is then added to bring the current volume of the beverage to about 1 quart (about 2½ cups ice, crushed), and the mixture is stirred, cooling the beverage. The remaining ingredients are then added, and the liquid is mixed well to combine the ingredients.

Those of skill in the art may immediately recognize that the list of ingredients in Example II and corresponding method of formulation may be modified to produce a larger or smaller volume of beverage through increasing or decreasing the listed ingredients proportionally. One of skill in the art also recognizes that differing types of tea may be utilized to achieve different flavors, as well as different types or amounts of juices. One may also recognize that ingredients used may be restricted to only certified organic ingredients, and water utilized in an embodiment of the drink may be carbonated. In addition, various natural or organic additives may be added to increase the nutritional value of the beverage, such as herbal extracts, brewed herbal teas, vitamins, minerals, amino acids such as L-Camitine, L-Lysine, Taurine, and the like.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. One of ordinary skill in the art will recognize that the processes just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

What is claimed is:

1. A beverage composition comprising:
48-58% water by volume;
0.09-0.16% salt by weight;
42-52% juice by volume; and,
an infusion from one or more tea compositions.

2. The beverage composition of claim 1 wherein said one or more tea compositions further comprise matter from the ilex paraguariensis plant.

3. The beverage composition of claim 1 wherein said juice further comprises:
10-13% grape juice by total volume of said beverage composition;
26-32% orange juice by total volume of said beverage composition; and,
5.4-6.6% concentrated apple juice by total volume of said beverage composition.

4. A method of preparing a beverage comprising the following steps:
(a) placing one or more tea compositions into a container;
(b) adding to the container a first water volume heated to a temperature of 160-190° F.;
(c) removing said one or more tea compositions from the container and press-expelling retained infusions into said container;
(c) adding to the container a sufficient quantity of ice to increase volume of said beverage by a second water volume;
(d) adding to the container an amount of salt;
(e) adding a volume of juice to the container; and
(f) mixing until ingredients are blended.

5. The method of claim 4, wherein:
said first water volume comprises about 0.48-0.59 liters of water;
said second water volume comprises about 0.48-0.59 liters of water;
said amount of salt comprises about 2-3 grams of salt; and,
said volume of juice comprises about 0.84-1.03 liters of juice.

6. The method of claim 5, wherein said volume of juice further comprises
about 0.2-0.4 liters grape juice;
about 0.5-0.7 liters orange juice; and
about 0.1-0.2 liters concentrated apple juice.

7. The method of claim 5, wherein said volumes and amount are multiplied by a scaling factor prior to preparing said beverage.

8. The method of claim 6, wherein said volumes and amount are multiplied by a scaling factor prior to preparing said beverage.

9. The method of claim 4, wherein said one or more tea compositions further comprise matter from the ilex paraguariensis plant.

10. A method for modifying the performance of a human being, said method comprising administering to said human being the beverage composition of claim 1.

11. The method of claim 10, wherein said administering is performed to ameliorate the effects of physical exertion.

12. The method of claim 10, wherein said administering is performed to assist in modifying said human being's body mass index.

13. The method of claim 10, wherein said administering is performed to improve hydration of said human being.

14. The method of claim 10, wherein said administering is performed to improve alertness of said human being.

15. The method of claim 10, wherein said administering is performed to improve attentiveness of said human being.

16. The method of claim 10, wherein said administering is performed to improve available metabolic energy of said human being.
